(19) United States
(12) Patent Application Publication
(10) Pub. No.: US 2024/0248011 A1
(43) Pub. Date: Jul. 25, 2024

(54) METHOD AND APPARATUS FOR IMAGING A BIOLOGICAL SAMPLE

(71) Applicant: LEICA MICROSYSTEMS CMS GMBH, Wetzlar (DE)

(72) Inventors: Soeren Alsheimer, Wetzlar (DE); Joachim Bradl, Wetzlar (DE)

(21) Appl. No.: 18/560,940

(22) PCT Filed: May 19, 2021
(86) PCT No.: PCT/EP2021/063334

§ 371 Date: Nov. 15, 2023

(51) Int. Cl. G01N 1/28; G01N 1/06; G01N 1/36; G01N 15/10

(52) U.S. Cl. CPC G01N 1/286; G01N 1/06; G01N 1/36; G01N 15/10; G01N 2001/2873; G01N 2001/2886; G01N 2015/1006

(57) ABSTRACT

A method for imaging a biological sample includes the steps of dividing the biological sample into a plurality of sample parts, wherein each sample part has a sphericity of at least 0.4 and has a volume in the range of 1000 μm3 to 27 mm3; embedding each of at least some of the plurality of sample parts into a discrete entity; and imaging the embedded sample parts.

### CROSS REFERENCE TO RELATED APPLICATIONS

This application is a U.S. National Phase application under 35 U.S.C. § 371 of International Application No. PCT/EP2021/063334, filed on May 19, 2021. The International Application was published in English on Nov. 24, 2022 as WO 2022/242853 A1 under PCT Article 21(2).

### FIELD

The invention relates to a method for imaging a biological sample. Further, the invention relates to a device for imaging a biological sample.

### BACKGROUND

For over a century, histological sections have been a key tool in biology and pathology. A long tradition of histology has brought about a vast number of staining protocols that are used to contrast tissue sections. Different fixation, sectioning, and staining protocols, reagents, and instruments are well known to someone skilled in the art. These include formalin-fixation (FF) and paraffin-embedding (PE) as well as embedding in media such as OCT for cryosectioning.

Histological analysis includes traditional staining protocols, such as Hematoxylin and Eosin (H&E), van Gieson, Toluidine Blue, Alcian Blue, Giemsa and Golgi staining, as well as fluorescence-based histological assays including immunohistochemistry, immunofluorescence, and fluorescent in situ hybridization (FISH). These techniques are generally performed on thin tissue sections, in particular for diagnosis of cancer and immune-related diseases, in order to contrast the specimen or label specific molecules. Such sections are generally derived from biopsies followed by fixation and embedding and typically have a thickness in the range of 2-15 μm. After embedding, the block containing the tissue sample is typically trimmed up to the point of interest and then sectioned using a microtome. Several variants of microtomes have been developed. U.S. Pat. No. 4,548,051 A discloses a cryostat comprising a cooling enclosure, which can be set to a predetermined internal temperature and a microtome inside the enclosure. U.S. Pat. No. 6,253,653 B1 discloses a disc-microtome with a rotating component.

However, the generation of thin tissue sections is a manual, time- and labour-intensive process requiring expensive equipment and skilled personnel. Further, the biopsy, from which the tissue sections are derived, can only be analysed slice by slice as the biopsy is sectioned. In turn, each tissue section can only be analysed in its entirety and by a limited number of histological analyses. Further, these thin tissue sections require very delicate handling that is difficult to automate.

### SUMMARY

In an embodiment, the present disclosure provides a method for imaging a biological sample. The method includes the following steps of dividing the biological sample into a plurality of sample parts, wherein each sample part has a sphericity of at least 0.4 and has a volume in the range of 1000 μm3 to 27 mm3; embedding each of at least some of the plurality of sample parts into a discrete entity; and imaging the embedded sample parts.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view of a biological sample;

FIG. 2 is a graph showing the sphericity of rectangular cuboids;

FIG. 3 is a schematic view of an embedded biological sample and embedded sample parts;

FIG. 4 is a schematic view of different sized sample parts;

FIG. 5 is a graph schematically illustrating properties of different types of biological samples;

FIG. 6 is a schematic view of a flow cell for imaging the embedded sample parts;

FIG. 7 is a flow chart of a method for imaging a biological sample;

FIG. 8 is a schematic view of a vessel containing a plurality of embedded sample parts;

FIG. 9 is a schematic view of an expanded embedded sample part;

FIG. 10 is a schematic view of a composite image of the biological sample;

FIG. 11 is a detailed view of the composite image;

FIG. 12 is a schematic view of the composite image and data extracted from the image;

FIG. 13 is a schematic view of an optofluidic system with a sorting device;

FIG. 14 is a schematic view of one of the embedded sample parts and cells contained in the sample part;

FIG. 15 shows a plurality of downstream profiles of molecular markers;

FIG. 16 shows schematically a match of an imaging profile and the downstream profile;

FIG. 17 shows schematically a match of single cell data set and the imaging profile;

FIG. 18 shows a 3D-microtome for dividing the biological sample;

FIG. 19 shows a second embodiment of a 3D-microtome for dividing the biological sample;

FIG. 20 shows a schematic top view of a conveyor belt of the 3D-microtomes according to FIGS. 18 and 19;

FIG. 21 shows a schematic top view of the conveyor belt and a secondary conveyor belt;

FIG. 22 shows a schematic side view of the arrangement shown in FIG. 21; and

FIG. 23 shows an illustration of the collection of location information and encoding of the location information.

### DETAILED DESCRIPTION

Embodiments of the present invention provide a method for imaging a biological sample and a device for imaging a biological sample that enable particularly detailed and efficient imaging of the biological sample.

In an embodiment, a method for imaging a biological sample is provided, the method comprising the following steps: dividing the biological sample into a plurality of sample parts, wherein each sample part has a sphericity of at least 0.4 and has a volume in the range of 1000 μm3 to 27 mm3; embedding at least some of the sample parts each into a discrete entity; imaging the embedded sample parts. This generates sample parts with a particularly low surface-area-to-volume ratio. This enables efficient imaging of the biological sample in three dimensions in form of the sample parts, whilst at the same time improving the ability to stain and/or label the individual sample parts with dyes or antibody conjugated dyes. The overall shape of the sample parts, in particular the low surface-area-to-volume ratio, further enables the embedding of sample parts in discrete entities, which enables the improved handling of the singularised plurality of sample parts, for example by pooling the sample parts in batches for efficient processing, automatically sorting the sample parts in a fluidic system, or imaging the sample parts in a flow cell. This is in contrast to thin tissue sections which are typically 1 μm to 50 μm in thickness whilst extending for several millimetres in width and length, resulting in high surface-area-to-volume ratios.

Alternatively or in addition, each sample part is shaped such that the ratio of its maximum spatial extent to its minimum spatial extent is lower than 10 and/or such that the maximum spatial extent is smaller than 3 mm.

Alternatively or in addition, each sample part is shaped such that the ratio of d/h is smaller than 30, the sum 1+b+h is greater than or equal to 30 μm and smaller than 15 mm, and b is greater or equal to h, with d being defined as the space diagonal, 1 as the length, b as the width, and h as the height or thickness of the smallest rectangular cuboid, in which a sample part can be fit in its entirety.

In a preferred embodiment of the method, the discrete entity is made of at least one polymeric compound, in particular of a hydrogel. This protects the sample parts within the discrete entity and enables particular easy handling of the sample parts. These discrete entities made of hydrogels are also named hydrogel beads.

In a preferred embodiment of the method, the discrete entity is made of at least one polymeric compound, in particular of a hydrogel, that can be disintegrated by at least one of melting, change of pH, enzymatic cleavage to release the included sample parts. This enables the retrieval of the included sample part for downstream analysis and/or cultivation of the included sample part or cells included in said sample part.

In a particular embodiment, the discrete entity has a spherical or spheroidal shape. This shape of the discrete entity results in similar hydrodynamic properties of each discrete entity, irrespective of the particular sample part and/or its individual size or shape embedded in the discrete entity. This enables particularly efficient handling of the sample parts.

In a preferred embodiment, the discrete entities are in a liquid. The sample parts embedded in the discrete entities are transported or contained in a liquid, in particular transported through a fluidic system, for example for imaging in a flow cell. This enables particularly efficient handling of the sample parts.

In a preferred embodiment, the sample is divided into the plurality of sample parts by cutting, shearing, sonication, and/or enzymatic digestion. This enables the efficient generation of the sample parts.

In a preferred embodiment, the sample is divided into the plurality of sample parts by means of at least one of a rotating cutter knife wheel, a reciprocating cutter knife array and a laser cutter. This enables the particularly precise generation of the sample parts.

In a particularly preferred embodiment, each sample part has a cuboid shape, in particular, a rectangular cuboid, a hexahedron or a parallelepiped. The cuboid shape is a polyhedron bounded by six quadrilateral faces. This enables the space-efficient division of the biological sample.

In a preferred embodiment, the images of the embedded sample parts are assembled into a composite image of the sample. The composite image is a two-dimensional, a multi-dimensional or preferably a three-dimensional representation of the biological sample. This enables displaying, viewing and analysing each sample part in the context of the biological sample.

In a preferred embodiment, the step of assembling comprises aligning and joining or attaching the images of the sample parts for generating the composite image, and this may also be named image stitching. During image stitching, distinctive features are found in each image of the sample parts, which are then matched to each other to establish correspondences between images. This enables quick generation of the composite image. The composite image might be generated from the complete sample or from a portion of the sample.

In a preferred embodiment, the step of assembling comprises combining the images of the sample parts based on location information relating to a location of each sample part within the sample. This narrows down the number of potential matches between images of the sample parts to those images that have an origin in the sample, which is nearby and therefore narrows down the computational capacity required to establish corresponding images. This enables particularly efficient generation of the composite image.

In a preferred embodiment, the step of dividing the sample comprises gathering and/or associating location information relating to the location of each sample part within the sample with the respective sample part. The location information may be a specific location of the sample part within the sample or it may be a general location within the sample, such as a section of the sample. The location information may further comprise relative location information, such as the order, in which the sample parts were generated when dividing the sample. The location information may be gathered optically by e.g. a monitoring camera. This enables placing each sample part in the context of the biological sample.

In a particular embodiment, at least one of the discrete entities, in particular the sample part it contains, is analysed by molecular biology techniques, in particular, proteomic, metabolomic, transcriptomic and/or genomic analysis. This generates analysis data, for example comprising information about molecular markers such as protein expression levels. This enables a particularly detailed analysis of the biological sample.

In a preferred embodiment, analysis data generated by the molecular biology techniques, in particular, proteomic, metabolomic, transcriptomic and/or genomic analysis, is superimposed on the composite image at the location of the respective sample part within the sample. This enables viewing and analysing each sample part in the context of the biological sample as well as the context of the analysis data.

In a particularly preferred embodiment, each discrete entity and/or each sample part comprises a marker. The marker, also named an identifying marker, comprises a light absorbing, fluorescent and/or coloured pattern, structure or distribution. The identifying marker can be optically read out by means of detecting the phase, the frequency, the polarization and/or the amplitude of light coming from the identifying marker. The identifying marker is generated or included during or after embedding of the sample part. This enables the identification of each discrete entity and/or of each sample part. Therefore, each embedded sample part can be identified. As an example for a discrete entity and/or a sample part comprising a marker, reference is made to the application PCT/EP2021/058785, the content of which is fully incorporated herein by reference.

In a preferred embodiment, the marker is associated with location information or the marker is generated based on the location information. The marker is generally read-out when imaging the embedded sample part. This enables revealing the location information for each embedded sample part upon identification of the particular embedded sample part through the marker, in particular, when the embedded sample parts were pooled in a vessel.

In a preferred embodiment, at least one of the discrete entities, in particular the sample part it contains, is dissociated into a plurality of single cells that are individually analysed by molecular biology techniques, in particular, microscopic, cytometric, proteomic, transcriptomic, metabolomic and/or genomic analysis. This generates analysis data, in particular single cell analysis data, for example comprising information about molecular markers such as protein expression levels of each of the single cells. This enables a particularly detailed analysis of each particular sample part and the biological sample.

In a particular embodiment, single cell analysis data generated by the molecular biology techniques, in particular, microscopic, cytometric, proteomic, transcriptomic, metabolomic and/or genomic analysis, is superimposed on the composite image at a location of the respective single cell within the sample. This enables viewing and analysing each single cell of a particular one of the sample parts in the context of the biological sample and the sample part as well as the context of the analysis data, in particular the single cell analysis data.

In a preferred embodiment, the location of the respective single cell within the sample is determined by tracking the origin of said single cell from one of the sample parts and by correlating levels of molecular markers determined in said sample part with levels of molecular markers determined in said single cell. This enables the identification of each discrete entity and/or of each sample part. This enables viewing and analysing each single cell of a particular one of the sample parts in the context of the biological sample and the sample part as well as the context of the analysis data, in particular the single cell analysis data.

In a further aspect, a device for imaging a biological sample is provided, comprising: at least one dividing unit configured to divide the biological sample into a plurality of sample parts, wherein each sample part has a sphericity of at least 0.4 and has a volume in the range of 1000 μm³ to 27 mm³; an embedding unit configured to embed at least some of the sample parts each into a discrete entity; and an imaging unit configured to image the embedded sample parts. The imaging unit may be an imaging system such as a microscope, in particular a light-sheet microscope. The technical advantages realised with this device are consistent with those explained in connection with the embodiments of the method.

In a preferred embodiment, the dividing unit comprises at least one of a reciprocating knife array, a rotary knife wheel and a laser cutter.

In particular, a monitoring unit can be configured to monitor the dividing process and to register location information of the generated sample parts.

In a preferred embodiment, an encoding unit is configured to generate a marker, which may at least comprise location information in the discrete entity.

In a preferred embodiment, a sorting unit is configured to sort discrete entities depending on image analysis of image data generated by the imaging unit for the respective discrete entity.

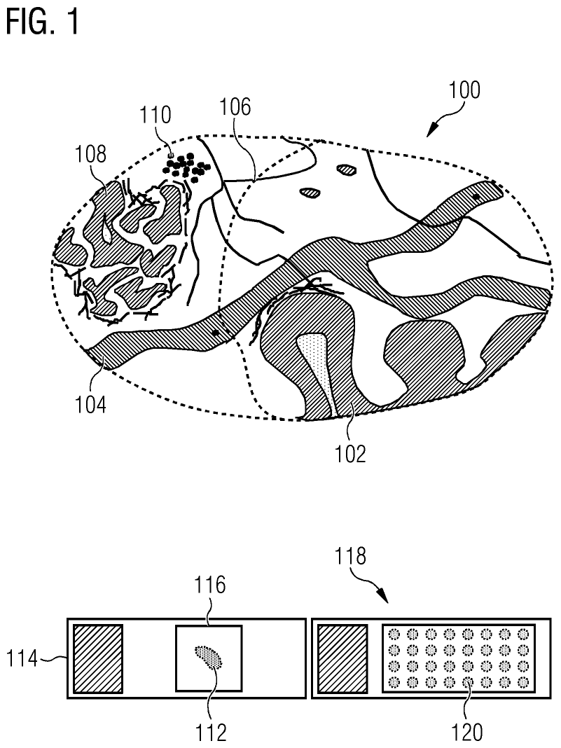

FIG. 1 shows a schematic view of a biological sample 100. The biological sample 100 is a tissue biopsy from a colon cancer patient, for example. The exemplified biological sample 100 is a three-dimensional structure of several millimetres in size and includes a variety of cell types and tissue types. These include colon crypts 102, blood and/or lymphatic vessels 104, axons of nerve cells 106, an adenocarcinoma 108, and a tumour microenvironment that is populated by a large number of immune cells 110.

Such tissue biopsies are crucial in the diagnosis of cancer and immune-related diseases. They may be excision biopsies (i.e. derive from the in toto excision of a malignant lesion) or an incision biopsy which removes only a small part of the tumour and neighbouring healthy tissue either by cutting or punching using a scalpel or a needle. Similarly, histological analysis of biopsies and organ or tissue explants is central to basic and translational research in biology, biomedicine, pharmacology and toxicology.

After obtaining the biological sample 100, it is fixed in formalin or other fixatives and then embedded in paraffin, a resin or a plastic. Following the embedding of the entire biological sample 100, the biological sample 100 is typically trimmed up to the point of interest and then sectioned using a vibratome, a microtome or a cryomicrotome. The created tissue sections 112 are then traditionally mounted on glass slides 114 and may be covered by a coverslip 116. Similarly, multiple tissue sections 112 may be mounted on the slide 114. In this case, tissue sections may be prepared in a way that allows for them to be arrayed forming what is referred to as a tissue microarray (TMA) 118, which holds multiple sections, which are referred to as tissue cores 120. Typical core diameters on TMAs are 0.6, 1.0, and 1.5 mm. For freely mounted tissue sections 112 sizes are typically in the mm to cm range in two dimensions as seen in FIG. 1.

Biological samples 100 such as tissue biopsies are generally irregularly shaped and may roughly approximate a spheroidal, cuboidal, cylindrical, or frustum-shaped geometry. In contrast, the sections 112 and the cores 120 are thin slices with a thickness in a range between 2 μm and 200 μm. In the plane of the cut, the sections 112 and cores 120 extend from several hundreds of micrometres to several millimetres. Here, the concept of sphericity (Y) is used to characterise the morphology of biological samples and the objects created when sectioning or dividing the biological samples (c.f. Li T, Li S, Zhao J, Lu P, Meng L. Sphericities of non-spherical objects. Particuology, 2012, 10(1), 97-104).

Sphericity (Ψ) is a measure for how close a certain geometrical structure approximates a sphere and is derived from the relation between the surface area of a sphere of the same volume as the structure to the surface area of said structure. Consequently, the sphericity of a sphere is Ψ=1.

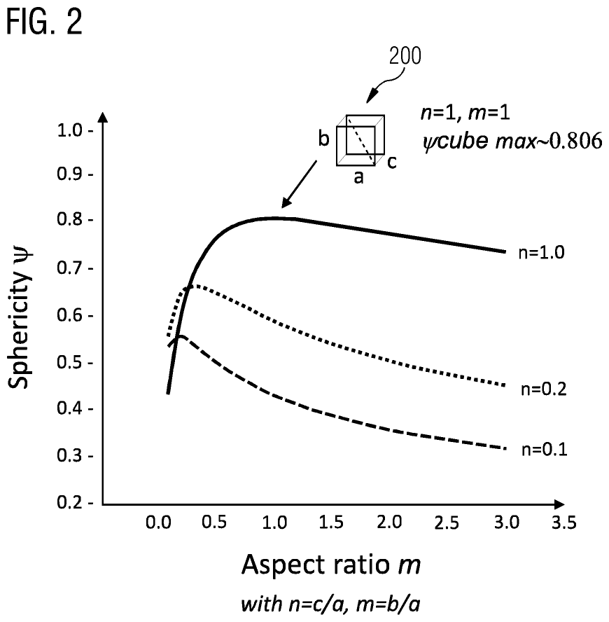

FIG. 2 is a graph (modified from: Li T, Li S, Zhao J, Lu P, Meng L. Sphericities of non-spherical objects. Particuology, 2012, 10(1), 97-104) showing the sphericity of rectangular cuboids. For the particular case of a cube 200, the sphericity Ψ is approximately 0.806. As shown in the graph, the sphericity of a rectangular cuboid depends on the aspect ratios n=c/a and m=b/a, with a being the length, b the width, and c the height or depth of the rectangular cuboid.

The sphericity Ψ of thin tissues sections (i.e. 2 to 15 μm thickness) prepared on microtomes is typically below 0.100. For example, a rectangular cuboid approximating a TMA core with a size of 600 μm by 600 μm by 5 μm has a sphericity Ψ of approximately 0.098. Further, a rectangular cuboid with a size of 10000 μm by 5000 μm by 5 μm has a sphericity Ψ of approximately 0.019.

The sphericity Y′ of thick tissue sections (i.e. 50 to 200 μm thickness) prepared on vibrating microtomes is generally below 0.300. Sections prepared on vibratomes are frequently prepared from larger biopsies that often extend over several millimetres in two dimensions. For example, a rectangular cuboid approximating a thick tissue section with a size of 10000 μm by 5000 μm by 200 μm has a sphericity Y of approximately 0.212.

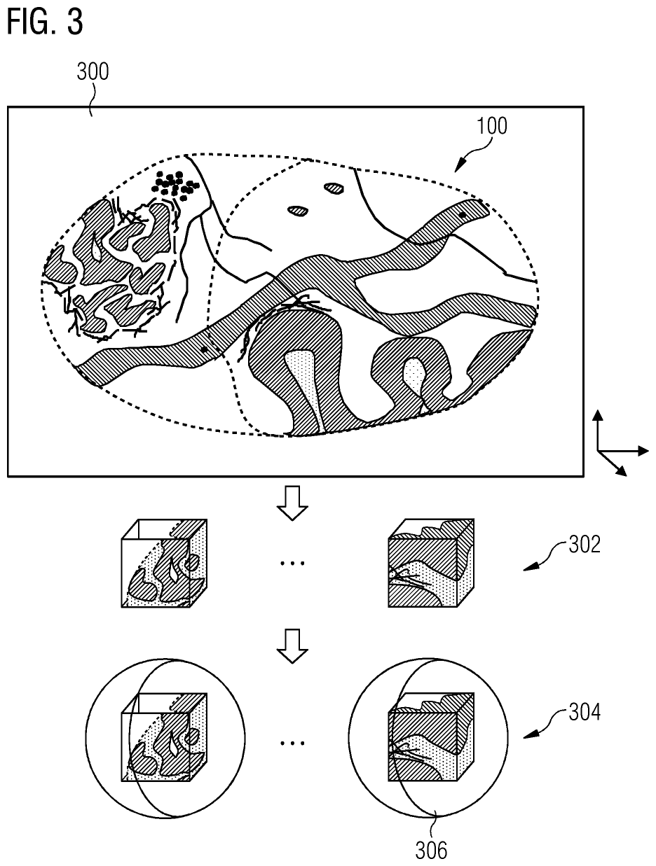

FIG. 3 shows a schematic view of the biological sample 100 embedded in an embedding medium 300 such as paraffin or a polymer, and embedded sample parts 304. The embedded sample parts 304 are generated by first dividing the embedded biological sample 100 into a plurality of sample parts 302, for example by means of a microtome and then embedding each sample part 302 into a discrete entity to form the embedded sample part 304. In contrast to the tissue sections described for FIG. 1, according to a first embodiment, the sample parts 302 have a sphericity Y′ in a range between 0.400 to 1. In a preferred embodiment, the sample parts 302 have a sphericity Y′ in a range between 0.600 to 1. In a particularly preferred embodiment, the sample parts 302 have a sphericity Y′ in a range between 0.700 to 1. In a further preferred embodiment, the sample parts 302 have a sphericity Y′ in a range between 0.750 to 1. For example, the sample parts 302 may have a cube-shape, with a side length of 50 μm and a sphericity Y of approximately 0.806. In this example, each sample part 302 comprises at least some of the cells 102 to 110 from the biological sample 100. The sample parts may have a volume in the range of 1000 μm³ to 27 mm³.

The discrete entity may be a hydrogel bead 306. The hydrogel bead 306 is made of a polymeric compound, in particular, a polymeric compound that forms a hydrogel and/or that is substantially transparent. The polymeric compound may be of natural or synthetic origin, including for example, agarose, alginate, chitosan, hyaluronan, dextran, collagen and fibrin as well as poly(ethylene glycol), poly(hydroxyethyl methacrylate), poly(vinyl alcohol) and poly(caprolactone). Further examples include basement membrane extracts, which may include Laminin I, Collagen I, Collagen IV, Vitronectin and Fibronectin amongst others, and extracellular matrix preparations, including for example, Cultrex, Matrigel, or Jellagel. The hydrogel bead 306 may be made of a single or several different polymeric compounds. The hydrogel bead may be made of polyacrylamide, which has a refractive index of 1.349 close to the refractive index of water. This is similar to agarose gels, which can be made with a refractive index of 1.3329 (0.4% agarose). Polyacrylamide gels are mechanically more stable, i.e. they are more resistant to compression and have higher elastic modulus at low and high strain. Polyacrylamide or similar synthetic gels may be preferable to other hydrogels in applications that require higher flow rates, e.g. in a flow chamber, or multiple rounds of imaging, e.g. by an iterative staining and/or imaging process, as described for example in PCT/EP2021/063310, the content of which is fully incorporated herein by reference.

The hydrogel bead 306 may comprise several different portions. For example, the hydrogel bead 306 may comprises portions such as an inner core, an outer layer around the core. Each of the portions can be made of a particular polymeric compound. Moreover, the portions may be made of other compounds that do not form hydrogels. Thus, the portions of the hydrogel bead 306 can each have different properties. These properties include physicochemical properties such as Young's modulus, refractive index, and chemical composition and functionalisation.

The shape of the hydrogel bead 306 is spherical. Alternatively, the hydrogel bead 306 may have a different shape such as a spheroid. The diameter of the hydrogel bead 306 is in the range of 15 μm to 10 mm. Particularly preferred ranges are 15 μm to 100 μm, 50 μm to 250 μm and 500 μm to 5 mm.

The hydrogel bead 306 can be formed, for example, by electrospray, emulsification, lithography, 3D printing and microfluidic approaches. During formation of the hydrogel bead 306 further compounds and structures can be included in the hydrogel bead 306. For example, the sample part 302 can be included in the hydrogel bead 306 to form the embedded sample part 304.

In addition, the hydrogel bead 306 may comprise an identifying marker. The identifying marker comprises a light absorbing, fluorescent and/or coloured pattern, structure or distribution. The identifying marker can be optically read out by means of detecting the phase, the frequency, the polarization and/or the amplitude of light coming from the identifying marker. The identifying marker are generated or included during or after embedding of the sample part 302.

For example, the identifying marker may be generated by means of lithography, in particular by photolithography, 2-photon lithography, or multi-photon lithography. Compounds can be included in the hydrogel bead 306 that can be activated, deactivated or bleached photochemically during or after formation of the hydrogel bead 306. In a subsequent lithographic, in particular in a photolithographic step, the compounds may be activated, deactivated or bleached photochemically by means of a focused light beam, or by imaging or projecting a pattern on the hydrogel bead 306. Using photolithography three-dimensional patterns can be generated comparable to barcodes. Such codes allow a large number of unique codes to be generated. This enables generating unique identifying markers in each hydrogel bead 306 of the embedded sample parts 304, such that each hydrogel bead 306 is distinguishable from the other hydrogel beads 306. Thus, each hydrogel bead 306 is identifiable by its identifying marker. Further information about at least one of a discrete entity, a hydrogel bead, a sample part comprising a marker, a marker, and a biological sample, is disclosed in the application PCT/EP2021/058785, the content of which is fully incorporated herein by reference.

Alternatively, the identifying marker comprises a plurality of microbeads, in particular fluorescent microbeads. The fluorescent microbeads are included and randomly dispersed in the hydrogel bead 306 during the formation of the hydrogel bead 306.

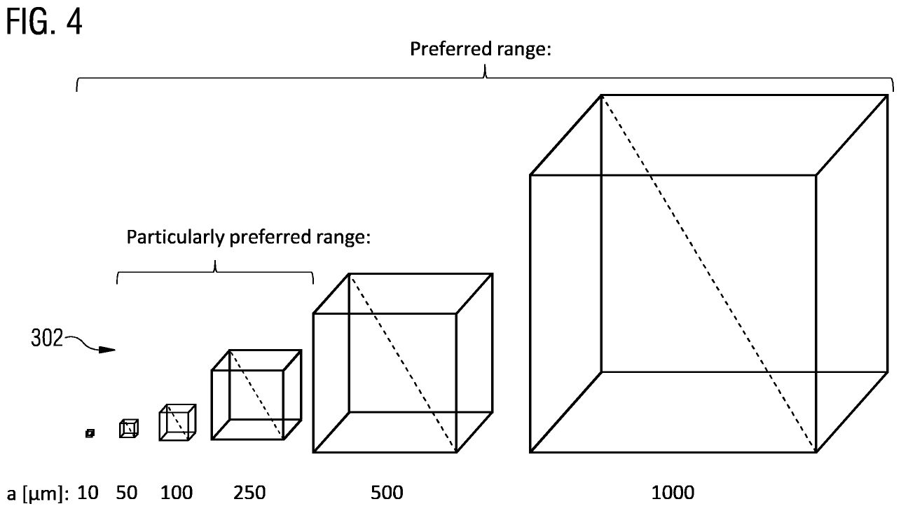

FIG. 4 shows a schematic view of different sized sample parts 302. The sample parts 302 are approximately cube-shaped with a side length a in a range between 10 μm to 3000 μm. In a preferred embodiment, the sample parts 302 have a side length a in a range between 10 μm to 1000 μm. In a particularly preferred embodiment, the sample parts 302 have a side length a in a range between 50 μm and 250 μm. These cube-shaped sample parts 302 have a sphericity Y of approximately 0.806. Alternatively or in addition, the sample part 302 may be defined by its volume, which is in a range between 1000 μm3 and 27 mm3.

The choice of size of the sample parts 302 and their sphericity are dependent on properties of the biological samples 100.

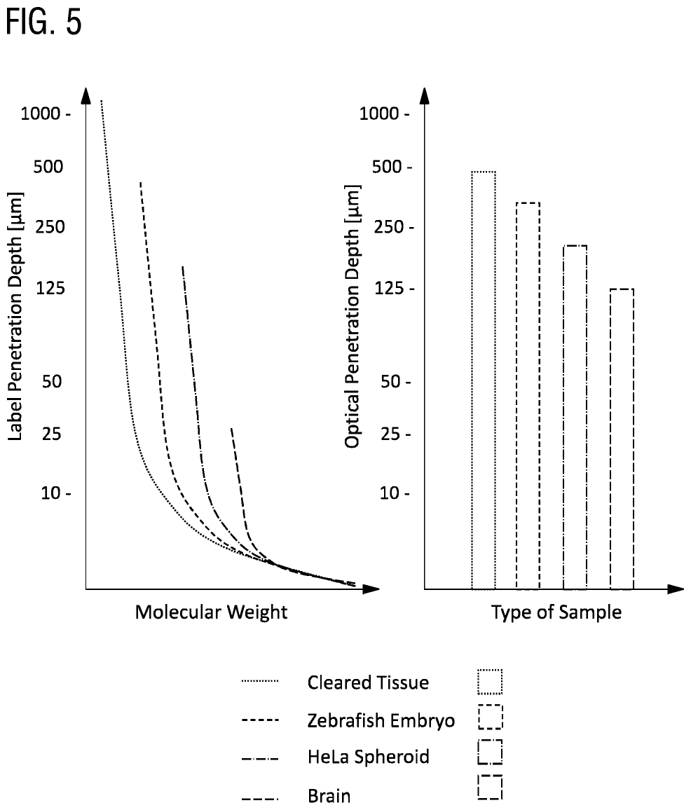

FIG. 5 is a graph schematically illustrating properties of different types of biological samples 100. The penetration of molecular labels, such as a dye-conjugated toxin or antibody, into the sample parts 302 varies with the molecular weight or size of the label and strongly depends on the properties of the biological sample 100. While some tissue types are comparably diffuse and allow for high label penetration depth in the range of 100s of μm, other tissue types such as brain tissue are very dense and labels tend to penetrate the tissue only for tens of μm. Similarly, some tissue types allow a very high optical penetration. For example, zebrafish embryo tissue is nearly transparent and thus are well suited to microscopic observation. Other tissue types may be opaque and only allow shallow microscopic observation. Optical penetration is typically limited in dense tissues such as brain tissue. In order to ensure sufficient optical penetration for imaging and label penetration for staining, the preferred size of the sample parts 302 is in a range between 10 μm and 1000 μm, as mentioned for FIG. 4.

The particularly preferred size range of the sample parts 302 between 50 μm and 250 μm is particularly advantageous in terms of label and optical penetration. Further, this range is preferable in terms of the number of cells in a single sample part 302. In addition, this range is preferable in terms of the diameter of the hydrogel bead 306. For example, a sample part 302 with a size of 50 μm by 50 μm by 50 μm may be embedded in a hydrogel bead with a diameter in the range between 75 μm and 100 μm. The sphericity Y of the sample part 302 ranging between 0.4 and 1 enables the sample part 302 being embedded in a hydrogel bead 306 with similar volume than the sample part 302.

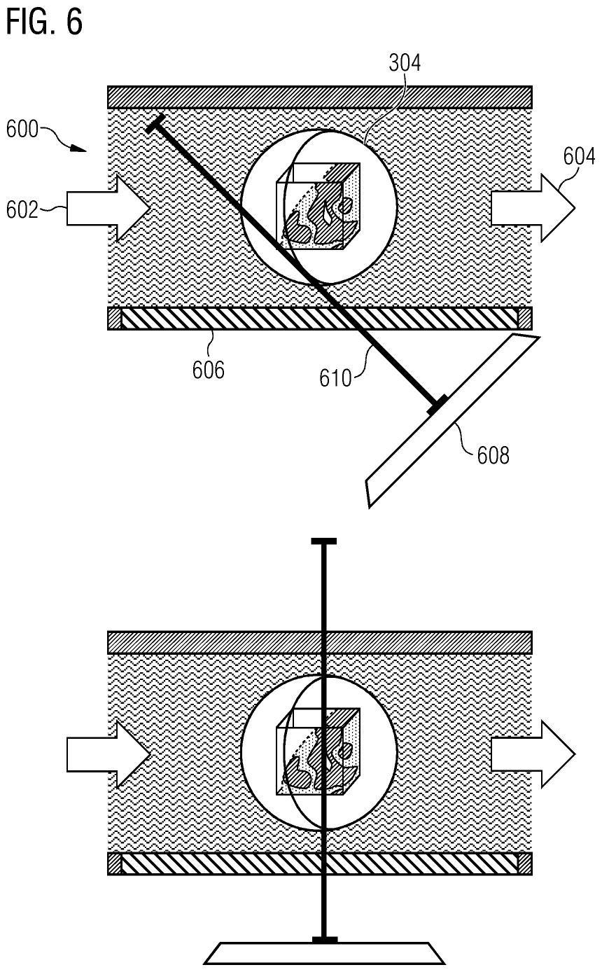

FIG. 6 shows a schematic view of a flow cell 600 for imaging the embedded sample parts 304. The flow cell 600 comprises an inflow 602, an outflow 604, a transparent window 606 and a microscope objective 608. For example, the objective 608 may be a water immersion objective with a numerical aperture of 1. The microscope objective 608 is part of a microscope and is used to image embedded sample parts 304 flowing through the flow cell 600. In particular, the microscope used for imaging may be a light-sheet microscope. The sample part 304 may be imaged from multiple views. In case the hydrogel bead 306 comprises the identifying marker, the marker may be imaged, as well. The free working distance 610 of the objective 608 depends on the type of objective, the numerical aperture, and other design choices. Free working distances of commonly used objectives with NAs ranging from 0.4 to 1.4 range from few microns to several millimetres. A HC FLUOTAR L 16×/0,80 IMM CORR VISIR objective has a free working distance of 8.15 mm whereas a HC APO L 20×/1,0 has a free working distance of 1.95 mm. Thus, the particularly preferred size range of the sample parts 302 between 50 μm and 250 μm is also advantageous in terms of the dimensions of the flow cell 600, in particular, the working distance 610 of the objective 608.

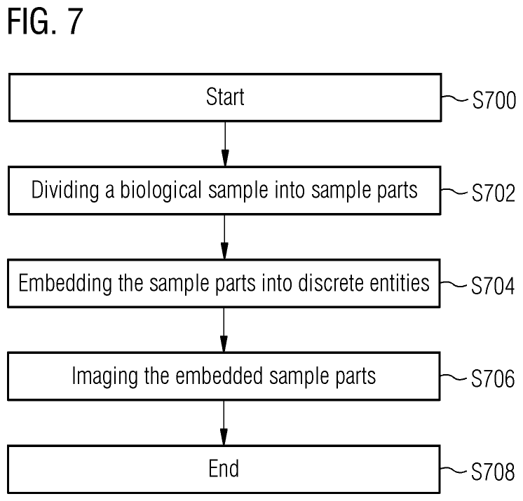

FIG. 7 shows a flow chart of a method for imaging the biological sample 100. The method starts with step S700. In step S702 the biological sample 100 is divided into the plurality of sample parts 302. In particular, the biological sample 100 may be embedded in the embedding medium 300 such as paraffin or a polymer. For dividing the sample 100, it may initially be sectioned into slices, which are subsequently further divided into the plurality of sample parts 302.

In step S704 at least some of the sample parts 302 are each embedded in a hydrogel bead. This generates the embedded sample parts 304. The embedding of the sample parts 302 may be performed by a microfluidic chip. Due to the spherical geometry of the hydrogel beads, the embedded sample parts 304 are particularly suited for transportation in a liquid through a fluidic system, for example a microfluidic chip.

In a step S706 the embedded sample parts 304, in particular the sample parts 302, are individually imaged, for example imaged in the flow cell 600 by means of the microscope, in particular a light-sheet microscope. The imaging of the embedded sample parts 304 may include shining illumination light on the embedded sample part 304, for example, in order to excite fluorescence of fluorescent linked molecular labels. When imaging the embedded sample parts 304 single or multiple views of the embedded sample parts 304 may be acquired, in particular an image stack or a time series of images may be acquired of each embedded sample parts 304. When the identifying marker is imaged together with the embedded sample part 304, the captured image stack may be associated with the identifying marker. The step S706 may be repeated over several iterations, for example, to acquire a time series of images of the embedded sample parts 304. When the iterative images of the embedded sample parts 304 are each associated with the identifying marker, the iterative images can be easily identified to be of a particular one of the embedded sample parts 304 and of a particular timepoint.

In addition, the embedded sample parts 304 may be stained or labelled prior to imaging of the embedded sample parts 304. The embedded sample parts 304 may be stained by a molecular label such as an antibody conjugated fluorophore or a dye. When the embedded sample parts 304 are imaged, light of the molecular label may be acquired as well, for example, the fluorescence of an antibody conjugated fluorophore may be recorded with the image.

The method ends with step S708.

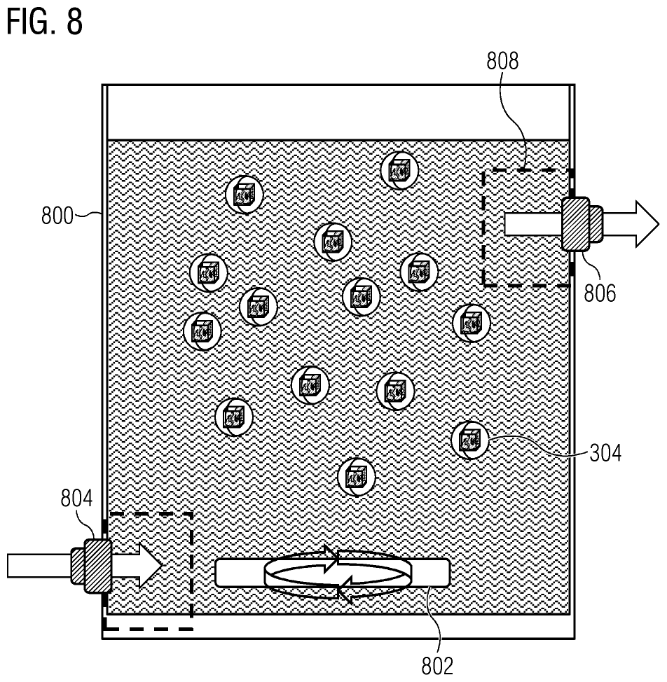

FIG. 8 shows a schematic view of a vessel 800 containing the plurality of embedded sample parts 304. As described for FIGS. 6 and 7, the embedded sample parts 304 may be generated, transported and imaged in the microfluidic chip, the fluidic system and the flow cell 600, respectively. The vessel 800 may be part of the fluidic system with the plurality of embedded sample parts 304 being stored in liquid in the vessel 800.

In addition, the embedded sample parts 304 can be stirred, shaken, rocked, or rotated, for example with a magnetic stirring bar 802, to mix staining or washing fluids. Further, when staining the embedded sample parts 304 the vessel 800 facilitates the continuous exchange of staining or washing fluids via, for example inflow 804 and outflow channels 806. The embedded sample parts 304 may be retained in the vessel 800 by means of a sieve 808 or filter with appropriate pore sizes. This enables automated staining and labelling of the embedded sample parts 304, for example with molecular labels such as fluorophore linked antibodies. The embedding of sample parts 302 in the hydrogel bead further protects the included sample part 302 from mechanical damage during staining, further sample processing, handling, fluidic movement and imaging.

Further, when the hydrogel bead 306 of the embedded sample parts 304 comprise identifying markers, a large number of embedded sample parts 304 are still individually identifiable in the vessel 800. In addition, markers of embedded sample parts 304 may be associated with further information. For example, embedded sample parts 304 from different biological samples 100 may be mixed in the vessel 800 for staining, whilst being able to identify each embedded sample part 304 based on the respective marker.

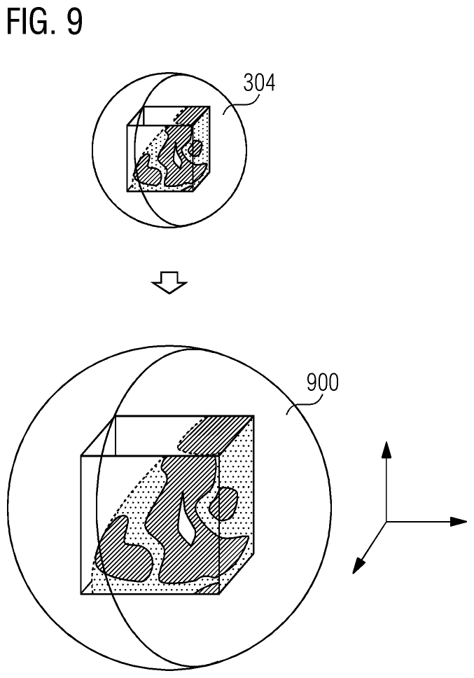

FIG. 9 shows a schematic view of an expanded embedded sample part 900. The embedding of sample parts 302 in hydrogel beads further facilitates expansion microscopy. In expansion microscopy samples are subject to a swelling step, which expands them in three dimensions with the aim of enlarging samples isotropically. This renders structures in the samples optically resolvable, i.e. increasing their size beyond the resolution limit of the imaging system, which is being used to image the sample. Expansion microscopy is an efficient approach to super resolution imaging, which circumvents the classical resolution limitation of microscopy by increasing the size of the sample. As expansion microscopy does not require sophisticated imaging systems, it offers significant cost advantages and has attracted considerable interest amongst users. At the same time, however, a problem is, that samples may not expand isotropically, i.e. the size of samples may not increase in all directions equally. In this regard, the ideal geometry for an expansion microscopy sample would be a sphere as the mechanical forces resulting from swelling the sample can be expected to be isotropical. For this reason, embedding of the sample parts 302 in spherical hydrogel or polymer beads facilitates their isotropic expansion.

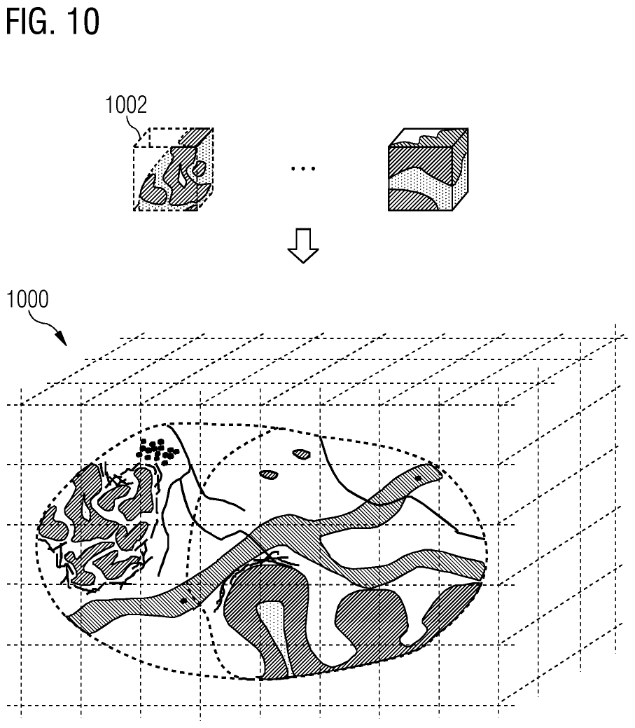

FIG. 10 shows a schematic view of a composite image 1000 of the biological sample 100 or parts of the biological sample 100. The images acquired in step S706 comprise individual image stacks 1002 of each embedded sample part 304. The image stacks 1002 may comprise a single image of the respective embedded sample part 304 or a series of images of the embedded sample part 304. The composite image 1000 of the biological sample 100 is assembled from the individual image stacks 1002 of the embedded sample parts 304 of the biological sample 100. This means, the image stacks 1002 are virtually combined to result in the composite image 1000. This is achieved by an algorithm, for example an image stitching algorithm. In case the image stacks 1002 comprise multiple images of the respective sample part 304, in particular a three-dimensional representation, the composite image 1000 may equally be a three-dimensional representation of the biological sample 100.

Alternatively or in addition, location information associated with each embedded sample part 304 may be used to assemble the composite image 1000. The location information comprises the relative location of the sample part 304 within the biological sample 100. This location information might be generated when dividing the biological sample 100. The location information of a particular one of the sample parts 302 can then be associated with the identifying marker. The location information associated with each embedded sample part 304 can then be used to assembled the composite image 1000. In particular, the location information may be utilised to place the image at the correct relative location in the composite image 1000. In particular, location information obtained during the dividing step may be used to narrow down the possible locations of a certain image, thus reducing the computational load to find the correct placement.

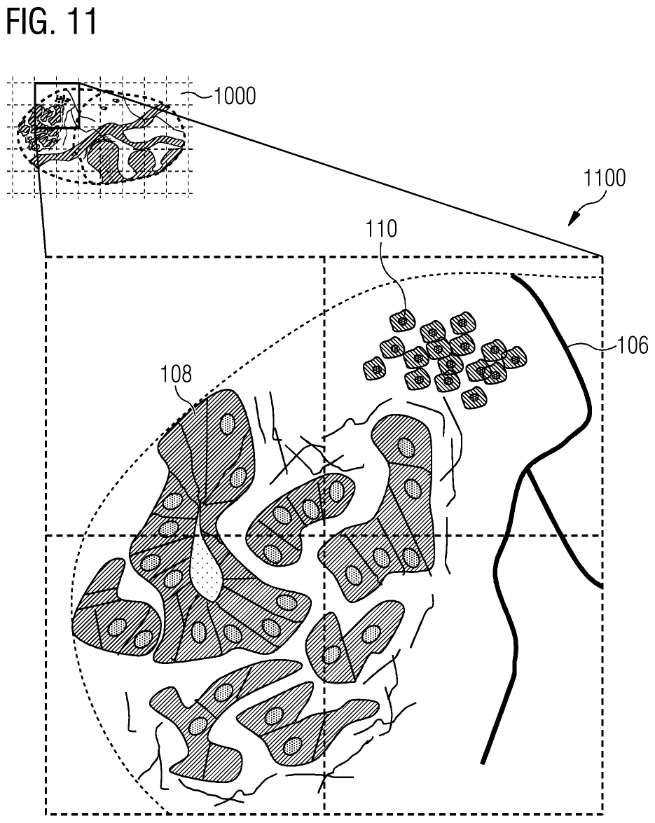

FIG. 11 shows a detailed view of the composite image 1000. The composite image 1000 allows a user to navigate to an area of interest 1100 and to zoom into the that area 1100. The level of zooming-in depends on the resolution of the microscope system used to acquire the image stacks 1002. The resolution may be high enough to resolve cells and perform observations on the single cell level, or subcellular structures, for example to analyse single cells and their subcellular structures of the adenocarcinoma 108. The spatial resolution of the composite image 1000 depends on the numerical aperture of the imaging system that is used to acquire the image data in step S706, which in turn is dependent on the illumination and detection point-spread-function of the respective objectives used for illuminating the sample with excitation light and detecting the light emitted from the sample. Further the spatial resolution depends on the number of views or perspectives that are acquired per image. Using multiple view acquisition, e.g. of the same sample part 304, followed by multi view deconvolution and fusion composite images can be achieved with close to isotropic resolution, i.e. the effective point spread function approaches the shape of a sphere, which means that the resolution is substantially the same in all spatial directions. Importantly, already 2 orthogonally arranged views yield substantial resolution improvement, i.e. a substantially quadratic point spread function, over the single view situation, which is characterized by an elliptical point spread function, i.e. lateral resolution is better than axial resolution. In a particularly preferred embodiment, image data in step S706 is acquired on an imaging system with at least two views arranged at an angle in the range of 60°-90° yielding a dataset with improved spatial resolution. In a particularly preferred embodiment, image data in step S706 is acquired on an imaging system with at least two substantially orthogonally arranged views yielding a dataset with a resolution that is close to the lateral resolution of the detection objective and where the numerical aperture of the detection objective is in the range of 0.8-1.0 yielding lateral resolutions in the 300-400 nm range at 520 nm. For example, a HC FLUOTAR L 16×/0,80 IMM CORR VISIR objective and HC APO L 20×/1,0 from Leica Microsystems or similar objectives lend themselves well for imaging in flow cells and fulfil these criteria.

This is particularly relevant in combination with staining or labelling the embedded sample parts 304 prior to the step of imaging the embedded sample parts 304. This enables, for example, the fluorescent labelling of a cell population of interest, such as the adenocarcinoma 108, or subcellular structures, such as organelles, proteins, molecules, and DNA.

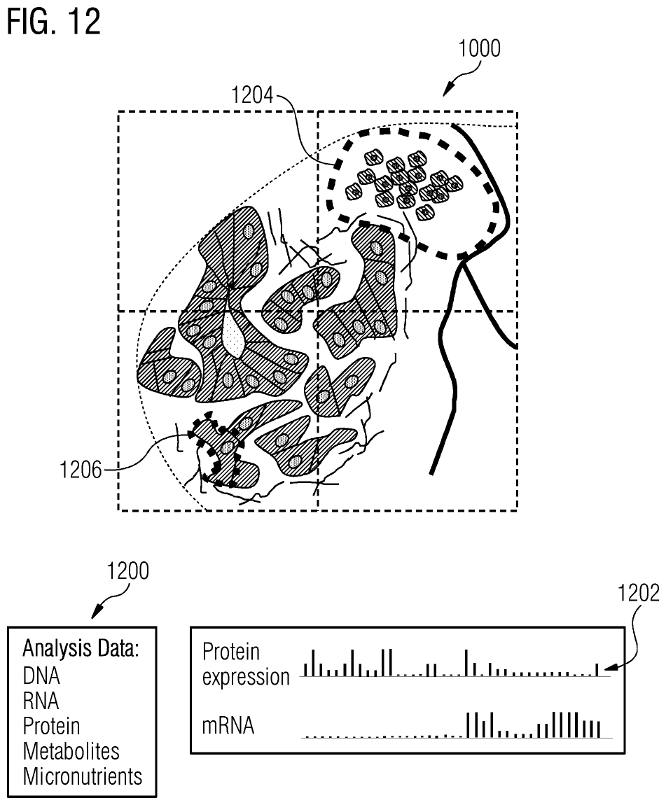

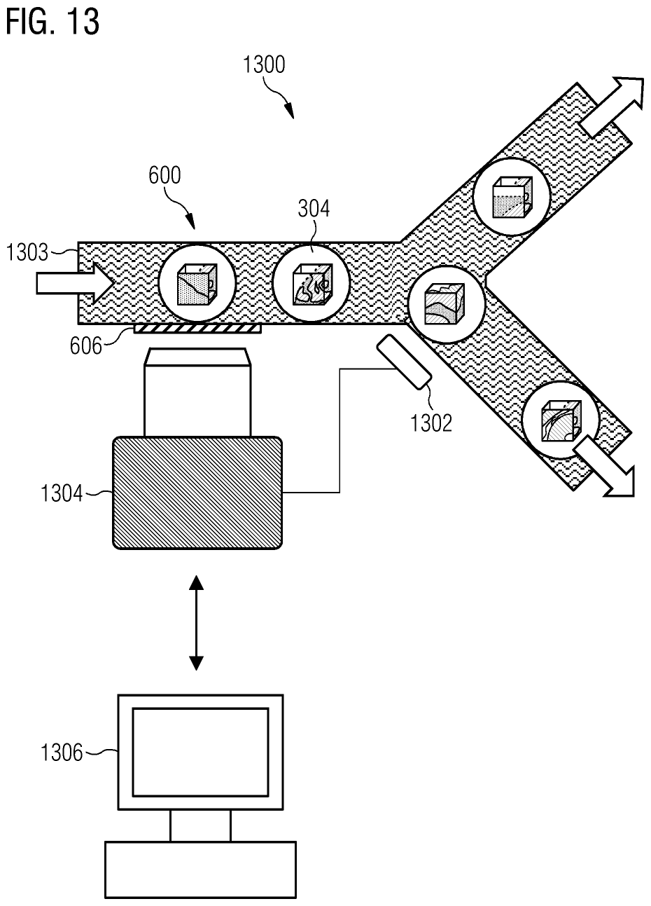

FIG. 12 shows a schematic view of the composite image 1000 and analysis data extracted from the composite image 1000. Using fluorescence microscopy molecular markers such proteins, RNA, DNA, and/or metabolites can be readout from the sample. Proteins are generally labelled either directly or indirectly using dye-conjugated antibodies or other dye-conjugated affinity reagent, while DNA and RNA sequences are commonly detected using fluorescence in situ hybridization, in which oligonucleotides are used to bind to a target DNA or RNA sequence. Primary affinity reagents such as antibodies, aptamers, and oligonucleotides may either be directly labelled with a fluorescent dye or may be detected using secondary affinity reagents and/or used as a basis for further enzymatic reactions, which generate the fluorescent or non-fluorescent label. Commonly used protocols for such staining include direct or indirect immunofluorescence and fluorescent in situ hybridization protocols. Such protocols generally include steps for washing the sample, permeabilizing the sample, blocking unspecific binding sites, incubation the sample with the affinity reagent and the label.

A typical widefield fluorescence microscope can distinguish on the order of 1 to 5 molecular labels based on spectral properties with excitation and emission wavelengths of light generally in the range of 350 nm to around 800 nm. Advanced confocal microscopes with a plurality of excitation lasers, and/or tuneable lasers, and spectral detectors with multiple channels are generally used to image 1 to 12 molecular labels. Multiplexed imaging methods have been developed that rely on iterative processes in which samples are stained, imaged, and blanked or deactivated in multiple rounds with each round yielding for example 5 markers. Such iterative processes have been used to generate imaging datasets with more than 60 markers.

The analysis data comprises information about molecular markers 1200 such as DNA, RNA, protein expression levels and metabolites. This data may be extracted from the image, which is acquired from the respective embedded sample part 304. In particular, the molecular markers 1200 are labelled with molecular labels, which comprise an optically detectable element such as a fluorescent dye, in order to enable acquiring the information optically when imaging the embedded sample part 304.

In addition, the imaging step S706 may employ multiplexed imaging methods that may be based on iterative staining and may lead to imaging profiles 1202 of the molecular markers 1200. For example, a protein expression profile may contain the expression values of 60 proteins and can be dynamically generated by analysing an area of the composite image 1000 that includes an area of interest 1204 or a particular cell of interest 1206. Thus, the analysis data of a retrospectively defined area of interest, such as the area of interest 1204 or the cell of interest 1206, can be extracted from the respective image data in order to generate the imaging profile 1202. For example, image data may be captured in ultra-high throughput on an imaging system that provides two orthogonally arranged views and numerical apertures of the detection objective in the range of 1.0. Following to multi-view registration, deconvolution, and fusion the effective point spread function would have a roughly quadratic shape and the resolution would be close to the lateral resolution of the detection objective in all directions, i.e. in the 350 nm range. For such a dataset the composite image 1000 may be divided into volumes of approximately 350×350×350 nm. Imaging profiles 1202 may thus be derived from volumes down to a size of approximately 350×350×350 nm from such a dataset. This means that imaging profiles 1202 can be derived from regions 1204 of the sample 100, groups of cells, single cells 1206 as well as for subcellular regions-of-interest. These imaging profiles 1202 may contain multiple data layers 1200 with analysis data such as proteins, DNA, RNA.

FIG. 13 shows a schematic view of an optofluidic system 1300 with a sorting device 1302. The optofluidic system comprises channels 1303, the flow cell 600 with at least one transparent window 606, an imaging system 1304 including a computer 1306 and the sorting device 1302. In addition, the optofluidic system 1300 may comprise pumps, controllers, inlets/outflows, and routing tubes. The embedded sample parts 304 are imaged in the flow cell 600 by the imaging system 1304 and the resulting images are analysed by the computer 1306. Depending on the analysis, the embedded sample parts 304 may be sorted by the sorting device 1302. For example, some of the embedded sample parts 304 that contain a particular structure of interest detected by the computer 1306 during image analysis may be sorted into a separate container.

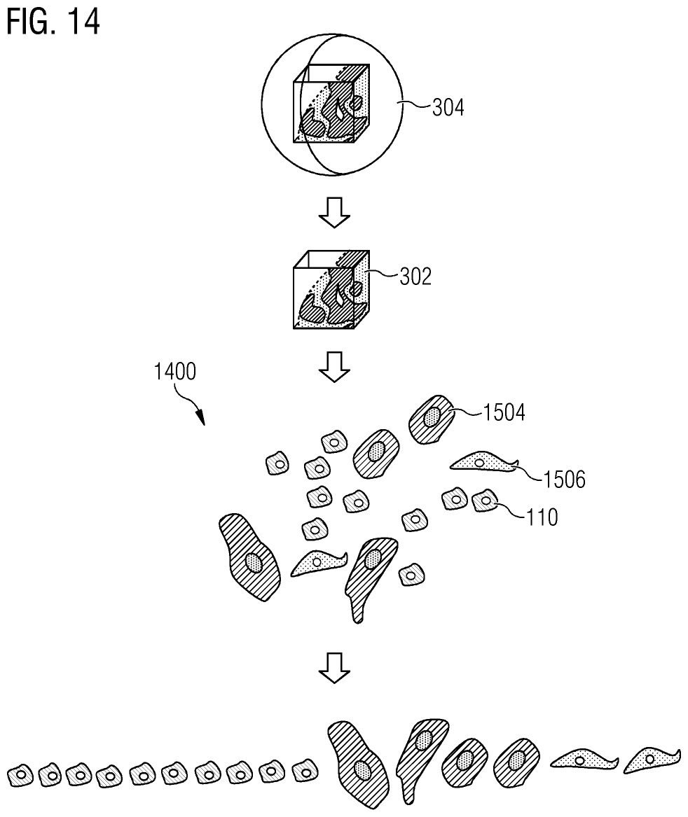

FIG. 14 shows a schematic view of one of the embedded sample parts 304 and cells contained in the sample part 302. In one embodiment the plurality of the embedded sample parts 304, in particular a sorted subset of the embedded sample parts 304, is subjected to a dissolution step. This includes dissolving the hydrogel or polymer, by means of heat (e.g. melting), chemically or enzymatically. Subsequently, the sample parts 302 may be subject to dissociation, which may be performed enzymatically to release a plurality of (single) cells 1400 included in the respective sample part 302.

This plurality of cells 1400 may then be subject to downstream processes such as downstream analysis and/or cultivation. At this point, it is possible to analyse the plurality of cells 1400 with downstream analysis in batch or as a cohort, i.e. their contents are released and mixed. Alternatively, or additionally the cells 1400 may be analysed as single or individual cells by means of various available single cell analysis solutions. Alternatively or in addition, the single cells may in a further step each be embedded in discrete entities.

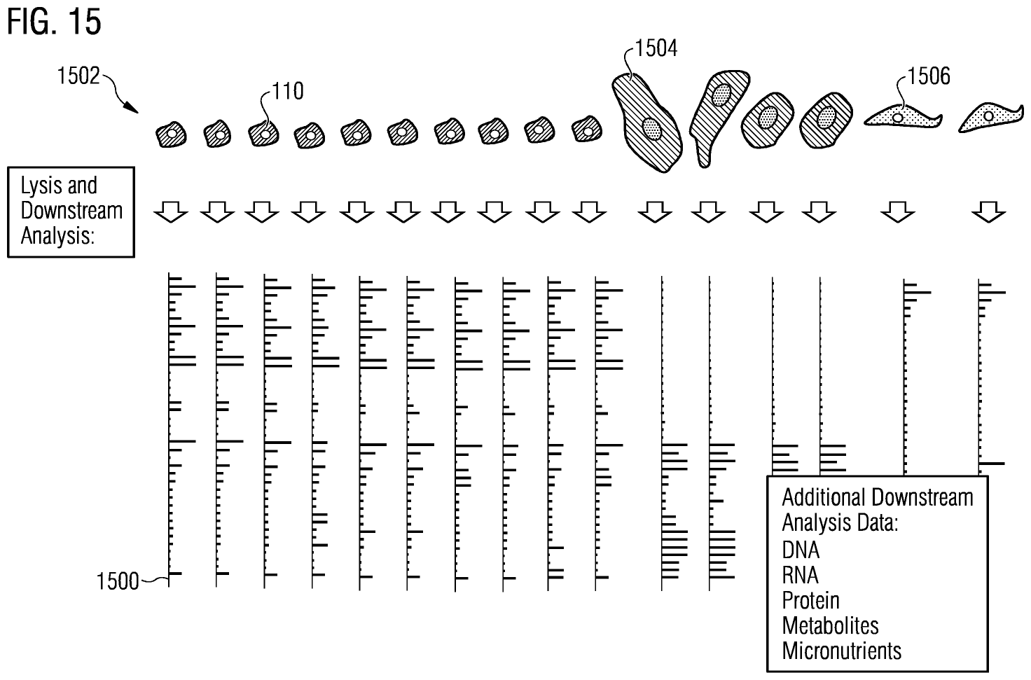

FIG. 15 shows a plurality of downstream profiles 1500 of molecular markers, in particular protein expression levels, as an example of additional analysis data obtained by downstream analysis. In particular, single cells 1502 may be subjected to multiple downstream analyses. The downstream analysis starts with lysing the cells 1502 releasing the contents and biochemically and/or genetically analysing the contents. This may use approaches like mass spectrometry to analyse the proteome, DNA or RNA sequencing or microarrays to perform genomic or transcriptomic analysis, and chromatin immunoprecipitation (ChIP) to assess transcription factor binding.

Generally, downstream profiles 1500 of molecular markers for single cells of a common lineage, such as immune cells 110, will exhibit very similar profiles 1500 albeit not identical profiles.

In the example provided in FIGS. 14 and 15 the sample part 302 of a size of approximately 50×50×50 μm is dissociated. Depending on the proportion between connective tissue or stroma to cell volume in the sample part 302 and the sizes of the cells, the number of cells in the sample part 302 may vary considerably. These parameters depend on the tissue type that makes up the sample part 302. As eukaryotic cells are typically in the 10 μm-100 μm diameter size range, with very small cells being in the 5 μm range, the number of cells in the sample part 302 may range from one cell to over a 1000. Most commonly, the number of cells in the sample part 302 may be in the range from 10-100 cells. Further, the plurality of the cells released from the sample part 302, may contains cells of different cell types. In the example shown in FIGS. 14 and 15 immune cells 110 of various cell types (e.g. NK-cells, T-Helper cells, B-cells), 4 enterocytes 1504 and 2 fibroblasts 1506 are released from the sample part 302. Thus, considering the large amount of different cell types, in particular in human biological samples, and the number of cells in a sample part 302, it is highly likely, that each sample part 302 has a unique combination and arrangement of cells. This enables matching the imaging profiles 1202 obtained by imaging the embedded sample parts to downstream profiles 1500.

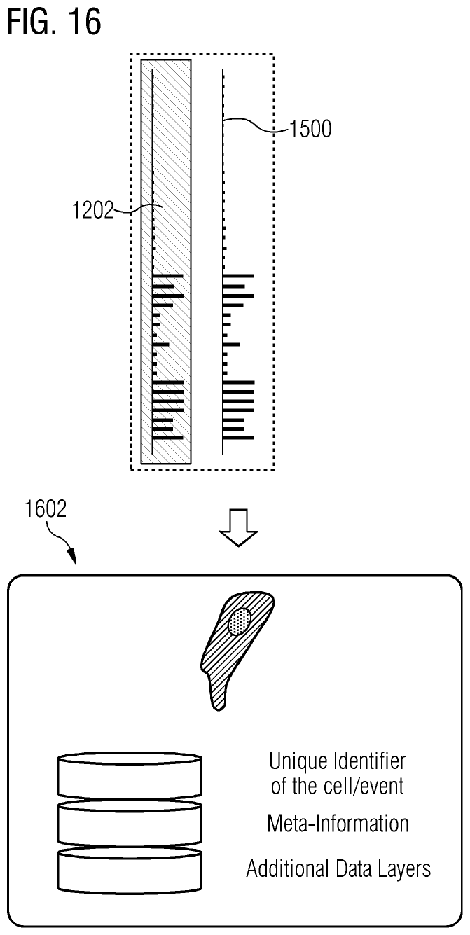

FIG. 16 shows schematically a match of the imaging profile 1202 and the downstream profile 1500. The imaging profile 1202 comprises analysis data generated when imaging the embedded sample part 304. The downstream profile 1500 comprises analysis data generated during downstream analysis of the sample part 302, in particular of a single cell. Thus, the downstream profile 1500 is part of a single cell data set 1602. The imaging profile 1202 comprises analysis data, which can usually only be measured optically and without compromising the cell or sample integrity, whereas the downstream profiles 1500 can include analysis data collected after disassociating the sample part and lysing the respective cells. Thus, the downstream profiles 1500 usually comprise additional analysis data, which is not collectable in the analysis data of the imaging profile 1202.

For example, the downstream profile 1500 may include data derived from high-throughput single cell proteomics, which may be obtained by the method described in Dou et al. Anal Chem. 2019; 91(20): 13119-13127 or other means. Such a downstream proteomic profile may contain the expression values of around 1,600 proteins. For instance, it may include the expression values of proteins that are also included in the imaging profile 1202. As shown in Dou et al. Anal Chem. 2019; 91(20): 13119-13127 the similarity of such profiles can be investigated using cluster analysis methods such as principal component analysis. Further as shown in Dou et al. Anal Chem. 2019; 91(20): 13119-13127, cells of the same or closely related cell type such as immune cells still exhibit substantially different expression profiles, which means that the likelihood that exactly the same expression signature appears twice amongst a plurality of cells of the same cell types is so low, that the number of unclear matches which would have to be rejected based on a user-defined statistical confidence score can be expected to be very low and practically of minor relevance.

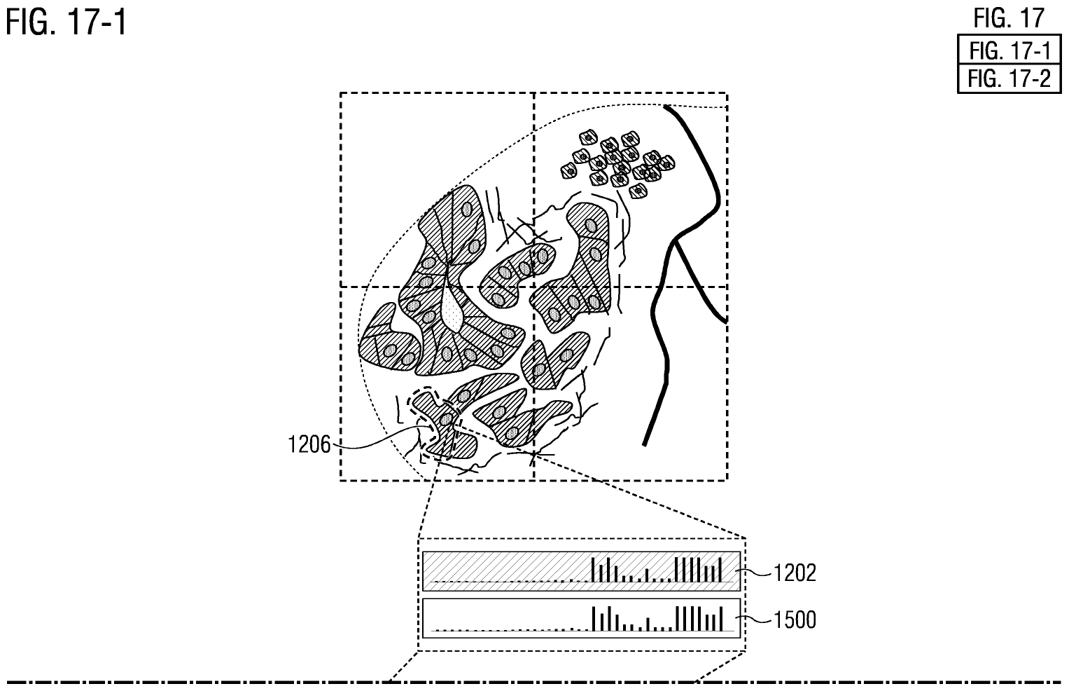

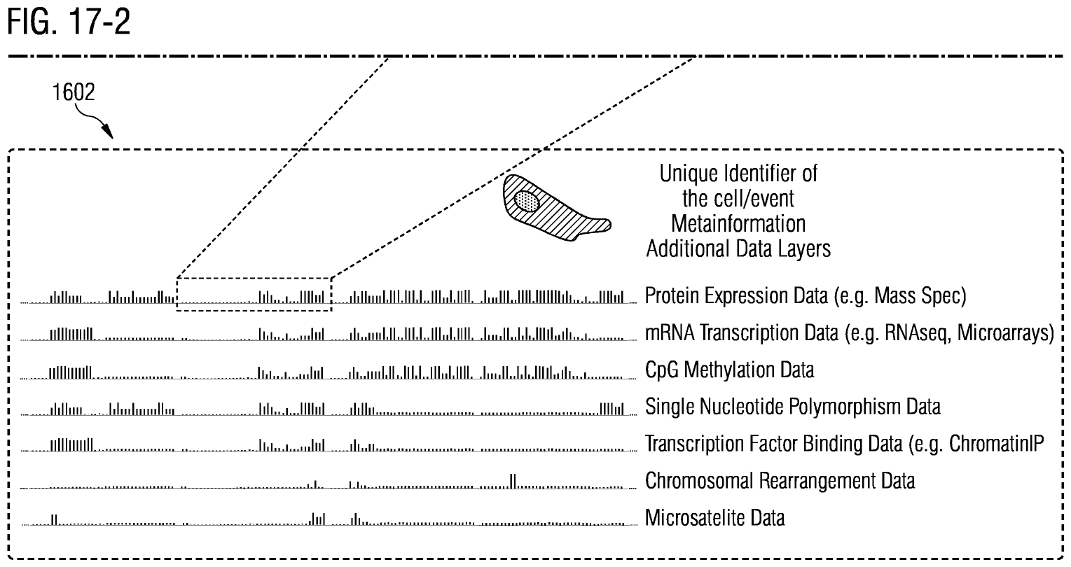

This observation is the foundation of the ability of the methods disclosed in this document to link the imaging data gathered e.g. by the imaging step S706 with the downstream analysis data resulting from the optional step S710, which is illustrated in FIGS. 16-17. In this way the presented methods directly connect the microscopy which provides spatial information with a multitude of biochemical and molecular biological analysis means. In this way the generally not spatially resolved information from biochemical, molecular biological, transcriptomic, proteomic, and genomic analysis can be put into the spatial context with cellular resolution and augments the microscopic data layer, whose spatial resolution is dictated by the effective point spread function of the imaging system used to capture the imaging data in the imaging step S706.

In addition, the single cell data set 1602 is labelled with a unique identifier of the cell or event, contains meta-information about the experimenter and the experiment. Further the single cell data set 1602 may contain information obtained before taking the biopsy, for example electronic health record data, data from wearables such as fitness trackers, as well as dietary information for example.

FIG. 17 shows schematically a match of the entire single cell data set 1602 and the imaging profile 1202. This is achieved by matching the limited imaging profile 1202 to the corresponding data from the single cell data set 1602 in form of the downstream profile 1500. This illustrates a particularly preferred embodiment: Due to the small size of the sample parts 302 it is possible to use imaging profiles 1202, which contain data for a limited set of measured molecular markers, to bridge from the composite image 1000, which contains information about the spatial relationships of sample parts 302 and may contain dynamic data from live measurements. Live measurements, in particular live imaging, may be made after dividing the sample and embedding the sample parts, however the sample parts are not fixed at this stage. Thus, these sample parts contain live tissue. After live measurements, the embedded sample parts may be fixed, stained, subjected to further imaging, iterative imaging and/or downstream analysis. A certain enterocyte in the tumour for example may be found to express a certain profile 1202 of 60 biomarkers through multiplexed immunofluorescence imaging. This imaging profile 1202 unequivocally identifies the single cell data set 1602, as discussed for FIG. 16. In this way the present invention enables the seamless connection of 3D imaging captured during step S706 or 4D imaging with additional single cell data in form of the single cell data set 1602. Thus, the preferred embodiment enables imaging the biological sample 100 in form of the three-dimensional sample parts 302 in combination with subsequent dissociation and analysis of user specified and sorted sample parts 302. The sorted sample parts 302 and resulting single cells may then be analysed for a large number of molecular markers.

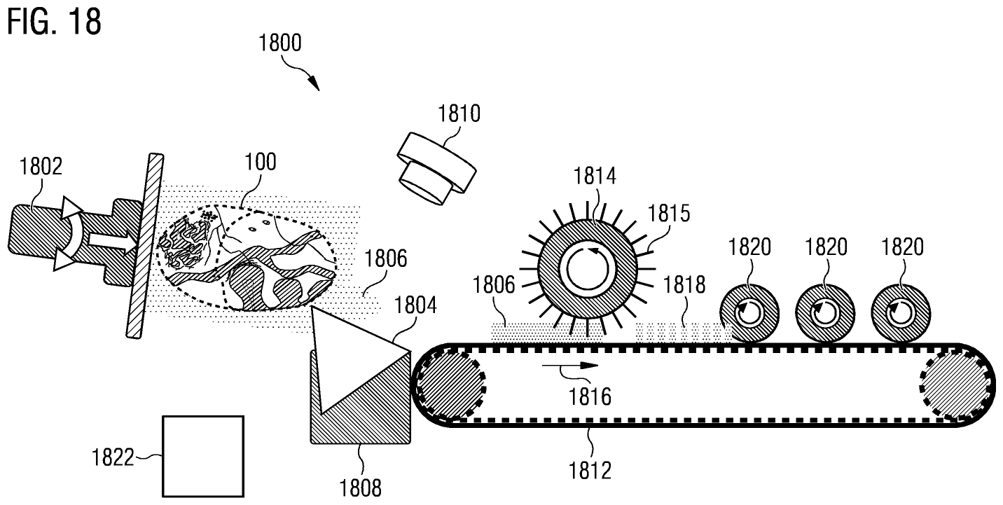

FIG. 18 shows a 3D-microtome 1800 for dividing the biological sample 100. In addition, the 3D-microtome may be configured to image the biological sample 100, in the form of a device for imaging the biological sample 100. The microtome 1800 comprises a sample positioning unit 1802, which holds the biological sample 100 that is embedded in paraffin, a resin or a polymer. Further, the sample positioning unit 1802 moves the sample 100 along the edge of a knife 1804 in order to cut a tissue section 1806 off the sample 100. The knife 1804 is mounted in a knife block 1808 of a primary dividing unit. In addition, the microtome 1800 comprises a camera 1810 of a monitoring unit, configured to monitor the dividing process. A conveyor belt 1812 is configured to transport the sections 1806 from the primary dividing unit to a secondary dividing unit and a tertiary dividing unit. The secondary dividing unit comprises a rotating secondary knife wheel 1814 with multiple blades 1815, which are aligned in a direction perpendicular to a transport direction 1816 of the conveyor belt 1812. The knife wheel 1814 divides the section 1806 into a plurality of stripes 1818 by cutting the tissues section 1806 along the transport direction 1816. The tertiary dividing unit comprises three rotating tertiary knife wheels 1820. The tertiary knife wheels divide the plurality of stripes 1818 into the sample parts 302 by cutting the stripes 1818 in a direction perpendicular to the transport direction 1816. The microtome 1800 further comprises a control unit 1822 configured to control the functions of the microtome 1800.

The secondary and tertiary dividing units may alternatively comprise a different number of knife wheels. In a further alternative, the primary, secondary and tertiary dividing units may comprise different dividing means, such as a laser cutter or a

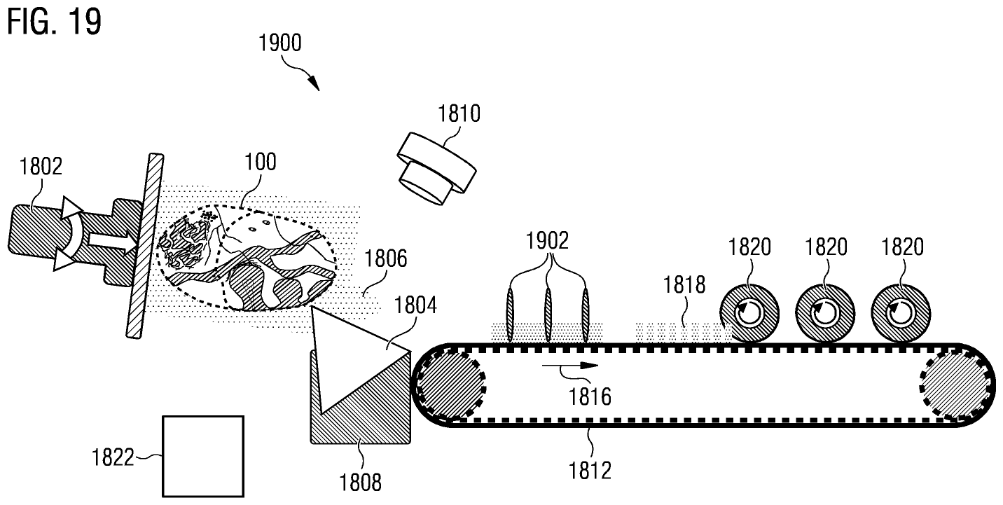

FIG. 19 shows a second embodiment of a 3D-microtome 1900 for dividing the biological sample 100. The microtome 1900 differs from the microtome 1800 in the secondary dividing unit comprising three knife wheels 1902 aligned to cut the sections 1806 into stripes 1818 in a direction perpendicular to the transport direction 1816.

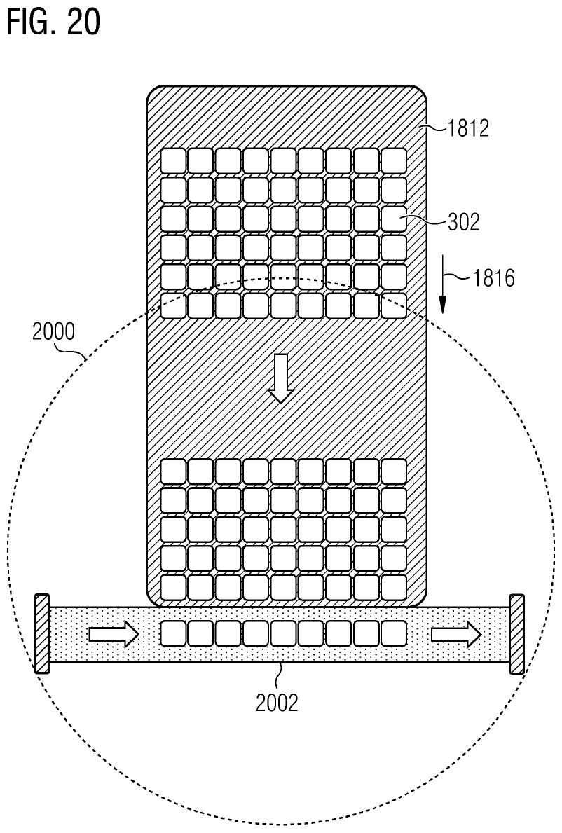

FIG. 20 shows a schematic top view of part of the conveyor belt 1812 of the 3D-microtomes 1800, 1900 with a plurality of the sample parts 302. The sample parts 302 are generated by the 3D-microtome 1800, 1900 by dividing the biological sample 100. When dividing the biological sample 100, the position of the generated individual sample parts 302 is maintained in the order in which the sample parts 302 where removed from the sample 100 and the position of the generated sample parts 302 is tracked within the microtome 1800, 1900. This means, that it is possible to collect the location information, comprising the original location of each sample part 302 within the biological sample 100, as the sample parts 302 are generated in the microtome 1800, 1900. The location information may include relative location information of the sample parts 302 to each other. This location information may be used when assembling the composite image 1000 of the sample 100. FIG. 20 further shows a monitoring area 2000, which is being monitored by the camera 1810 of the monitoring unit to track the origin and location of sample parts 302 inside of the 3D-microtome 1800, 1900. Sample parts 302 are released from the conveyor belt 1812 and dropped into a fluidic channel 2002 for further transport. The fluidic channel 2002 transports the sample parts 302 to an embedding unit, which is configured to embed the sample parts 302 in the hydrogel bead 306 to form the embedded sample part 304.

In addition, the microtome 1800, 1900 may comprise an encoding unit, which is configured to encode the location information collected by the monitoring unit as well as further information into the respective hydrogel bead 306 in form of the marker. The location information collected by the monitoring unit, in particular by the monitoring camera 1810, is the location of each sample part 302 in the biological sample 100, for example. Alternatively, the location information may be less precise and only comprise the section 1806 and/or stripe 1818 one of the sample parts 302 originated from. When assembling the composite image 1000, only the sample parts 302 originating in a particular one of the sections 1806 and/or stripes 1818 might be compared and stitched together to assemble the composite image 1000.

The microtomes 1800, 1900 may be configured to image the biological sample 100, for example, the embedding unit, which forms the embedded sample parts 304, may be connected to the optofluidic system 1300 comprising the imaging system 1304. Thus, the embedded sample parts 302 generated from the biological sample 100 are imaged by the imaging system 1304 in order to assemble the composite image 1000 of the biological sample 100.

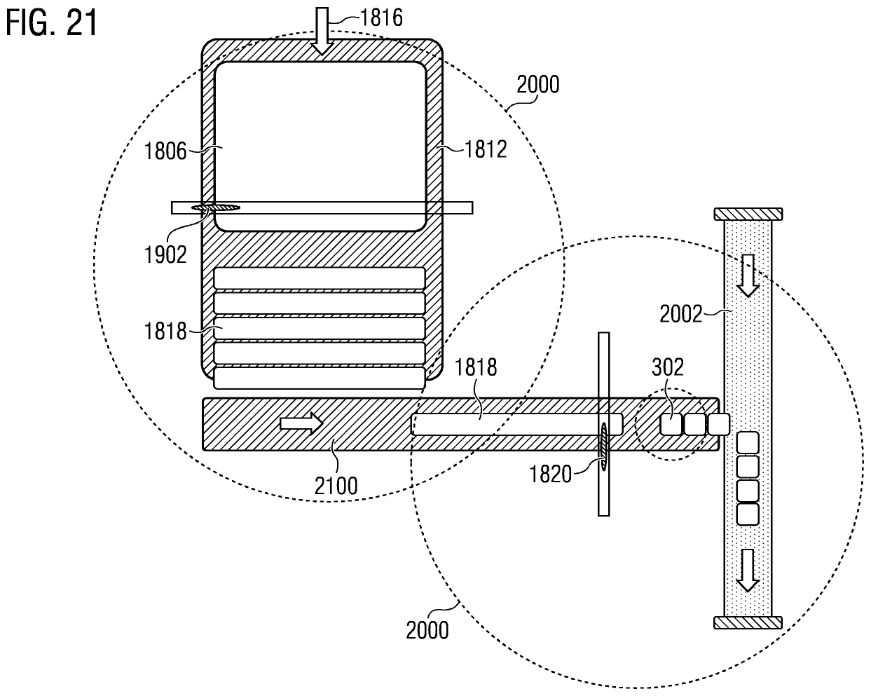

FIG. 21 shows a schematic top view of the conveyor belt 1812 and a secondary conveyor belt 2100. The secondary conveyor belt 2100 is perpendicular to the conveyor belt 1812. The secondary dividing unit operates by moving the rotating knife wheel 1902 from one side of the conveyor belt to the other and back thereby cutting the tissue section 1806 into stripes 1818. Alternatively, this might be accomplished by a laser cutter. FIG. 21 further shows how stripes 1818 are transported to the rotating knife wheel 1820 of the tertiary dividing unit, which cuts the tissue stripe 1818 into sample parts 302, which are then dropped into the fluidic channel 2002 for further transport. Alternatively to the rotating knife wheel 1820 of the tertiary dividing unit, a laser cutter might be used to cut the tissue stripe 1818 into sample parts 302. FIG. 21 further shows the monitoring area 2000, which is being monitored by the camera 1810 of the monitoring unit to track the origin and location of sample parts 302 inside of the 3D-microtome 1800, 1900.

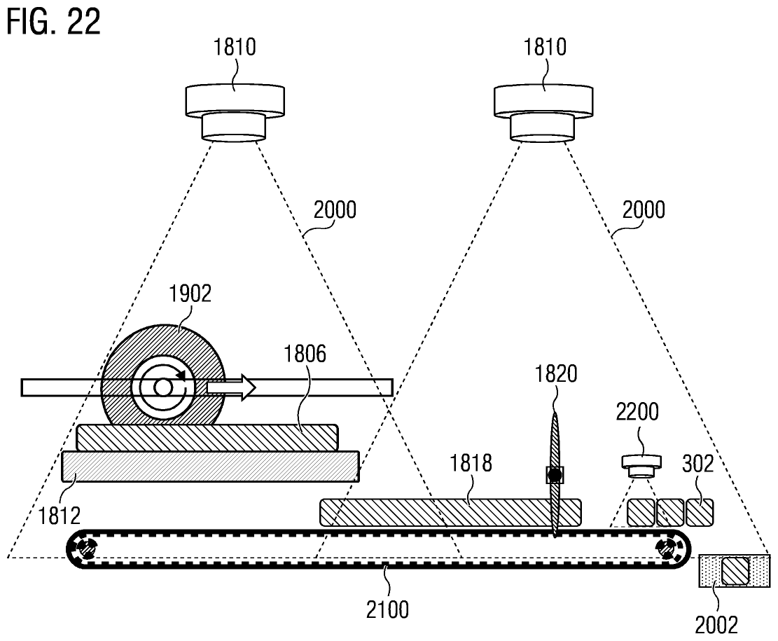

FIG. 22 shows a schematic side view of the arrangement shown in FIG. 21. Conveyor belts 1812, 2100 of the 3D-microtomes 1800, 1900 may additionally comprise a pre-imaging unit 2200, such as a transmitted light unit, configured to pre-image the sample parts 302 prior to embedding. This allows to quickly identify sample parts 302 that contain histological features that are of no interest to the user, such as connective tissue. A pre-sorting unit may additionally be provided, which removes undesirable sample parts 302 prior to embedding.

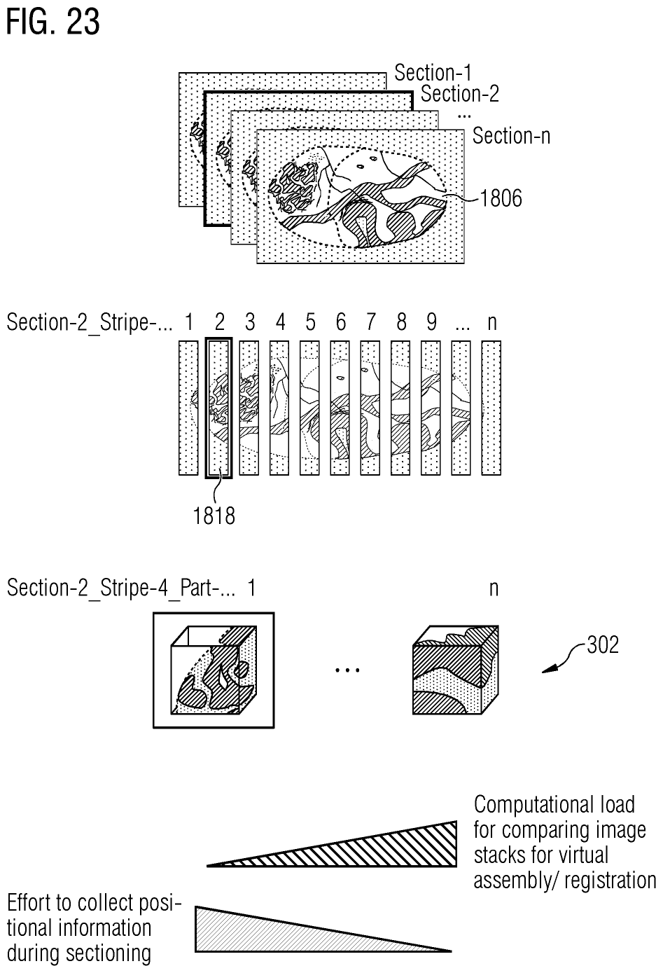

FIG. 23 shows an illustration of the collection of the location information and encoding of the location information into the hydrogel beads 306 by the encoding unit. The location information is encoded in form of the marker and can be read-out during the imaging step of the sample parts 304.

The monitoring unit may collect the location information for all sample parts 302, for stripes 1818, and/or sections 1806. In the case of collection location information for all sample parts 302, it would be possible to assemble the entire composite image 1000 simply using the location information obtained during the dividing step, as the marker encodes a precise location of the sample part 302 in the biological sample 100. Thus, in this case, the focus is on gathering location information during the dividing step.

In contrast, when only relying on algorithms to assemble the composite image, the focus is shifted to the assembling step. This can require greater computational capacity, caused by the necessity to compare all sample parts 302 with each other to compute the correct relative location based on correlations of the image information the images of the sample parts 302 contain. In a particularly preferred embodiment both cases are combined, this is advantageous as the effort of collecting a subset of the location information during dividing is low and the reduction on the computational load is high as knowing, for example, the stripe 1818 from which a sample part 302 originates significantly reduces the number of comparisons that need to be made in order to assemble the composite image 1000.

As an example, a biopsy of approximately 3 mm length×2 mm width and 1 mm height may be sectioned into 60 sections 1806 each yielding 40 stripes 1818 each generating 20 sample parts 302. Knowing to which stripe 1818 one of the sample parts 302 belongs reduces the number of potential placements of the sample part 302 from approximately 48,000 down to 20 and thus significantly reducing computational load and increasing robustness when assembling the composite image.

As used herein the term “and/or” includes any and all combinations of one or more of the associated listed items and may be abbreviated as “/”.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 Biological sample
102 Colon crypt
104 Lymphatic vessel
106 Nerve cells
108 Adenocarcinoma
110 Immune cell
112 Tissue section
114 Glass slide
116 Coverslip
118 Tissue micro array
120 Tissue core
200 Cube
300 Embedding medium
302 Sample part
304 Embedded sample part
306 Hydrogel bead
600 Flow cell
602 Inflow
604 Outflow
606 Transparent window
608 Microscope objective
610 Working distance
800 Vessel
802 Stirring bar
804 Inflow channel
806 Outflow channel
808 Sieve
900 Expanded embedded sample part
1000 Composite image
1002 Image stack
1100, 1204 Area of interest
1200 Molecular marker
1202 Imaging profile
1206 Cell of interest
1300 Optofluidic system
1302 Sorting device
1303 Channel
1304 Imaging system
1306 Computer
1500 Downstream profile
1502 Single cell
1504 Enterocyte
1506 Fibroblast
1602 Single cell data set
1800, 1900 3D-Microtome
1802 Positioning unit
1804 Knife
1806 Tissue section
1808 Knife block
1810 Camera
1812 Conveyor belt
1814, 1820, 1902 Knife wheel
1815 Blade
1816 Transport direction
1818 Tissue stripes
1822 Control unit
2000 Monitoring area
2002 Fluidic channel
2100 Secondary conveyor belt
2200 Pre-imaging unit

1. A method for imaging a biological sample, comprising the following steps:
dividing the biological sample into a plurality of sample parts, wherein each sample part has a sphericity of at least 0.4 and has a volume in the range of 1000 μm³ to 27 mm³;
embedding each of at least some of the plurality of sample parts into a discrete entity; and
imaging the embedded sample parts.

2. The method according to claim 1, wherein the discrete entity is made of at least one polymeric compound of a hydrogel.

3. The method according to claim 1, wherein the discrete entity has a spherical or spheroidal shape.

4. The method according to claim 1, wherein each discrete entity is in a liquid.

5. The method according to claim 1, wherein the sample is divided into the plurality of sample parts by cutting, shearing, sonication, and/or enzymatic digestion.

6. The method according to claim 1, wherein the sample is divided into the plurality of sample parts by means of at least one of a rotating cutter knife wheel, a reciprocating cutter knife array, and/or a laser cutter.

7. The method according to claim 1, wherein each of the sample parts has a cuboid shape.

8. The method according to claim 1, wherein images of the embedded sample parts are assembled into a composite image.

9. The method according to claim 8, wherein the step of assembling comprises stitching the images of the embedded sample parts for generating the composite image.

10. The method according to claim 8, wherein the step of assembling comprises combining the images of the embedded sample parts based on location information relating to the location of each embedded sample part within the sample.

11. The method according to claim 1, wherein the step of dividing the sample comprises associating location information relating to the location of each sample part of the plurality of sample parts within the sample with the respective sample part.

12. The method according to claim 1, wherein at least one sample part contained by the respective discrete entity is analysed by molecular biology techniques comprising at least one of proteomic, metabolomic, transcriptomic and/or genomic analysis.

13. The method according to claim 12, wherein analysis data generated by the molecular biology techniques comprising at least one of proteomic, metabolomic, transcriptomic and/or genomic analysis, is superimposed on a composite image at the location of the respective sample part within the sample.

14. The method according to claim 1, wherein each discrete entity and/or each sample part comprises a marker.

15. The method according to claim 14, wherein the marker is associated with location information or wherein the marker is generated based on the location information.

16. The method according to claim 1, wherein at least one sample part contained by the respective discrete entity is dissociated into a plurality of single cells that are individually analysed by molecular biology techniques comprising at least one of microscopic, cytometric, proteomic, transcriptomic, metabolomic and/or genomic analysis.

17. The method according to claim 16, wherein single cell analysis data generated by the molecular biology techniques comprising at least one of microscopic, cytometric, proteomic, transcriptomic, metabolomic and/or genomic analysis, is superimposed on a composite image of the embedded sample parts at a location of the respective single cell within the sample.

18. The method according to claim 17, wherein the location of the respective single cell within the sample is determined by tracking the origin of the respective single cell from one of the sample parts and by correlating levels of molecular markers determined in the respective sample part with levels of molecular markers determined in the respective single cell.

19. A device for imaging a biological sample, comprising:
at least one dividing unit configured to divide the biological sample into a plurality of sample parts, wherein each sample part has a sphericity of at least 0.4 and has a volume in the range of 1000 μm3 to 27 mm³;
an embedding unit configured to embed each of at least some of the plurality of sample parts into a discrete entity; and
an imaging unit configured to image the embedded sample parts.

20. The device according to claim 19, wherein the dividing unit comprises at least one of a reciprocating knife array, a rotary knife wheel, and/or a laser cutter.

21. The device according to claim 19, wherein a monitoring unit is configured to monitor the dividing process and to register location information of the generated plurality of sample parts.

22. The device according to claim 19, wherein an encoding unit is configured to generate a marker in the discrete entity and comprises locating information.

23. The device according to claim 19, wherein a sorting unit is configured to sort the discrete entities depending on image analysis of image data generated by the imaging unit for the respective discrete entity.
